(19) United States
(12) Patent Application Publication
(10) Pub. No.: US 2011/0033683 A1
(43) Pub. Date: Feb. 10, 2011

(54) CO-EXTRUSION AND METHOD OF MAKING A CO-EXTRUSION

(75) Inventor: Michael Thomas, Salisbury (AU)

Correspondence Address: ROSENBAUM & SILVERT, P.C., 1480 TECHNY ROAD, NORTHBROOK, IL, 60062, US

(73) Assignee: Oakmoore Pty Ltd, Salisbury (AU)

(21) Appl. No.: 12/676,876

(22) PCT Filed: Sep. 17, 2008
(86) PCT No.: PCT/AU2008/001375

§ 371 Date: Oct. 26, 2010

(30) Foreign Application Priority Data
Sep. 17, 2007 (AU) 2007905051

(51) Int. Cl. B32B 7/02; B29C 47/06; B23P 11/00; B29C 47/04

(52) U.S. Cl. 428/213; 264/173.18; 29/428

(57) ABSTRACT

A co-extrusion comprising at least one clear layer and at least one coloured layer wherein the at least one clear layer comprises approximately 50 to 95% of the total thickness of the co-extrusion and the at least one coloured layer comprises approximately 5 to 50% of the total thickness of the co-extrusion, the co-extrusion having a light transmittance of between 0 and 30% and providing a look of painted glass is disclosed.

### FIELD OF THE INVENTION

The present invention relates to a co-extrusion and method of making a co-extrusion. In particular, but not exclusively, the present invention relates to a co-extrusion having two or more layers that is able to achieve a look similar to painted glass.

### BACKGROUND TO THE INVENTION

Co-extrusion is a process whereby multiple layers of material are extruded simultaneously and are combined together into one product. An advantage of coextrusion is that each layer of the product imparts a desired characteristic property, such as stiffness, impermeability or resistance to some environment, all of which would be not commercially feasible to attain with any single material. The properties of co-extruded sheets make them preferable in many applications to products made from a single plastic that have a coating, such as a paint, applied. This is because such coatings can be difficult to apply, are not always retained by the plastic and can be easily scratched off. Accordingly, co-extruded sheets are used in many applications where properties are desired that are not commercially achievable with any single material.

One such co-extruded sheet is the polished translucent co-extruded sheet described in U.S. Pat. No. 6,878,436 that is made up of a particle layer, comprised from beads blended with a thermoplastic, and a substrate layer that together produce a sheet that hides LED light sources, distributes the light and achieves a look similar to that achieved with embossing, which is a more difficult and time-consuming manufacturing process than co-extrusion.

JP 92-255463/31 teaches a co-extrusion that has a high light transmittance for use in edge-light, plane luminescing applications such as, computer monitors.

DE 3730452 discloses a complex process in which layers are combined through independent flow channels to make a co-extrusion which has a base layer onto which a number of coloured layers are applied and which are then covered with a transparent glossy plastic.

The process described in JP 09-216268 produces a co-extrusion that has a base layer of even thickness and a coat layer of uneven thickness. The coat layer incorporates a matting agent designed to produce a wood grain effect generated by colour transmission through the layer of uneven thickness.

JP 10296828 and JP 10296829 disclose a method of varying overall colour by varying the thickness of individual layers of coloured and transparent materials to produce a transparently coloured co-extrusion that has a high light transmittance.

EP 0464790 teaches a transparent three layered sheet product that has a wedge-shaped coloured section in the middle and transparent edges, the product has a high light transmittance and is used in applications such as, architectural, automotive and aeronautical glazing applications where such a high light transmittance is required.

Accordingly, there remains a need for new co-extruded sheets to suit particular needs and demands.

Any discussion of the prior art throughout the specification should in no way be considered as an admission that such prior art is widely known or forms part of the common general knowledge in the field.

### OBJECT OF THE INVENTION

It is an object of the invention to provide a co-extrusion and/or a method of producing a co-extrusion. A preferred object is to provide a co-extrusion that has a look similar to painted glass.

It is an also an object of this invention to overcome or alleviate one or more of the above disadvantages of the prior art and/or provide the consumer with a useful or commercial choice.

Further objects will be evident from the following description.

### SUMMARY OF THE INVENTION

The present invention is broadly directed to a co-extrusion that has a look similar to painted glass and to a method of producing a co-extrusion that has a look similar to painted glass.

In a preferred form the co-extrusion has at least one clear layer and at least one coloured layer. The at least one clear layer may be thick and the at least one coloured layer may be thin. The co-extrusion may have a light transmittance between 0 and 30% to provide a look of painted glass. In one embodiment the light transmittance is between 0 and 20%. Preferably the light transmittance is between 0 and 10%. More preferably the light transmittance is between 0 and 5%.

In a first aspect, although it need not be the only, or indeed the broadest form, the invention resides in a co-extrusion comprising at least one clear layer and at least one coloured layer wherein the at least one clear layer comprises approximately 50 to 95% of the total thickness of the co-extrusion and the at least one coloured layer comprises approximately 5 to 50% of the total thickness of the co-extrusion, the co-extrusion having a light transmittance of between 0 and 30% and providing a look of painted glass.

In one form of the first aspect the light transmittance may be between 0 and 10%.

In another form of the first aspect the light transmittance may be between 0 and 5%.

In still another form of the first aspect the at least one clear layer may comprise approximately 60 to 95% of the total thickness of the co-extrusion and the at least one coloured layer may comprise approximately 5 to 40% of the total thickness of the co-extrusion.

In yet another form of the first aspect the co-extrusion may comprise one clear layer and one coloured layer.

In another form of the first aspect the co-extrusion may comprise two clear layers and one coloured layer wherein the two clear layers comprise approximately 50 to 95% of the total thickness of the co-extrusion and the one coloured layer comprises approximately 5 to 50% of the total thickness of the co-extrusion.

In still another form of the first aspect the co-extrusion may comprise two clear layers and two coloured layers wherein the two clear layers comprise approximately 50 to 95% of the total thickness of the co-extrusion and the two coloured layers comprise approximately 5 to 50% of the total thickness of the co-extrusion.

In yet another form of the first aspect the co-extrusion may comprise one clear layer and two coloured layers wherein the one clear layer comprises approximately 50 to 95% of the total thickness of the co-extrusion and the two coloured layers comprise approximately 5 to 50% of the total thickness of the co-extrusion.

In another form of the first aspect the co-extrusion may be a sheet.

In still another form of the first aspect an outer clear layer of the at least one clear layer may be on a critical side of the co-extrusion.

In yet another form of the first aspect the co-extrusion may have a hard coating applied to one or both of a critical side and a non-critical side.

In another form of the first aspect each of the at least one clear layer and each of the at least one coloured layer may have an even or substantially even thickness.

In a second aspect the invention resides in an article comprising the co-extrusion according to the first aspect.

The article may be a sheet suitable for use as a wall, partition, splashback and/or barrier.

The article may be freestanding.

The article may be supported by a frame or other support.

In a third aspect the invention resides in an assembly comprising a co-extrusion mounted to a carrier, wherein the co-extrusion comprises at least one clear layer and at least one coloured layer, the at least one clear layer comprising approximately 50 to 95% of the total thickness of the co-extrusion and the at least one coloured layer comprising approximately 5 to 50% of the total thickness of the co-extrusion, an outer clear layer of the at least one clear layer comprises an outer layer of the co-extrusion when mounted to the carrier, the co-extrusion has a light transmittance of between 0 and 30% and provides a look of painted glass.

In one form of the third aspect the light transmittance may be between 0 and 10%.

In another form of the third aspect the light transmittance may be between 0 and 5%.

In still another form of the third aspect the at least one clear layer may comprise approximately 60 to 95% of the total thickness of the co-extrusion and the at least one coloured layer may comprise approximately 5 to 40% of the total thickness of the co-extrusion.

In yet another form of the third aspect the co-extrusion may comprise one clear layer and one coloured layer.

In another form of the third aspect the co-extrusion may comprise two clear layers and one coloured layer wherein the two clear layers comprise approximately 50 to 95% of the total thickness of the co-extrusion and the one coloured layer comprises approximately 5 to 50% of the total thickness of the co-extrusion.

In still another form of the third aspect the co-extrusion may comprise two clear layers and two coloured layers wherein the two clear layers comprise approximately 50 to 95% of the total thickness of the co-extrusion and the two coloured layers comprise approximately 5 to 50% of the total thickness of the co-extrusion.

In yet another form of the third aspect the co-extrusion may comprise one clear layer and two coloured layers wherein the one clear layer comprises approximately 50 to 95% of the total thickness of the co-extrusion and the two coloured layers comprise approximately 5 to 50% of the total thickness of the co-extrusion.

In another form of the third aspect the co-extrusion may be a sheet.

In still another form of the third aspect the outer clear layer may be a critical or outer side of the co-extrusion.

In yet another form of the third aspect the co-extrusion may have a hard coating applied to one or both of a critical side and a non-critical side.

In one form of the third aspect each of the at least one clear layer and each of the at least one coloured layer may have an even or substantially even thickness.

In another form of the third aspect the assembly may comprise a splashback.

In a fourth aspect the invention resides in a method of making a co-extrusion including aligning at least one clear material from at least one extruder and at least one coloured material from at least one co-extruder into a combined melt stream to thereby make the co-extrusion, wherein the at least one clear material comprises approximately 50 to 95% of the total thickness of the co-extrusion and the at least one coloured material comprises approximately 5 to 50% of the total thickness of the co-extrusion, the co-extrusion having a light transmittance of between 0 and 30% and providing a look of painted glass.

In one form of the fourth aspect the light transmittance may be between 0 and 10%.

In another form of the fourth aspect the light transmittance may be between 0 and 5%.

In still another form of the fourth aspect the at least one clear material may comprise approximately 60 to 95% of the total thickness of the co-extrusion and the at least one coloured material may comprise approximately 5 to 40% of the total thickness of the co-extrusion.

In yet another form of the fourth aspect one clear material from one extruder may be aligned with one coloured material from one co-extruder.

In another form of the fourth aspect two clear materials from two extruders may be aligned with one coloured material from one co-extruder and the two clear materials may comprise two clear layers comprising approximately 50 to 95% of the total thickness of the co-extrusion and the one coloured material may comprise one coloured layer comprising approximately 5 to 50% of the total thickness of the co-extrusion.

In still another form of the fourth aspect two clear materials from two extruders may be aligned with two coloured materials from two co-extruders and the two clear materials may comprise two clear layers comprising approximately 50 to 95% of the total thickness of the co-extrusion and the two coloured materials may comprise two coloured layers comprising approximately 5 to 50% of the total thickness of the co-extrusion.

In yet another form of the fourth aspect one clear material from one extruder may be aligned with two coloured materials from two co-extruders and the one clear material may comprise one layer comprising approximately 50 to 95% of the total thickness of the co-extrusion and the two coloured materials may comprise two layers comprising approximately 5 to 50% of the total thickness of the co-extrusion.

In another form of the fourth aspect the co-extrusion may be a sheet.

In still another form of the fourth aspect an outer clear layer of the at least one clear layer may be on a critical side of the co-extrusion.

In yet another form of the fourth aspect the co-extrusion may have a hard coating applied to one or both of a critical side and a non-critical side.

In another form of the fourth aspect each of the at least one clear layer and each of the at least one coloured layer may have an even or substantially even thickness.

In a fifth aspect the invention resides in an article produced by the fourth aspect.

In a sixth aspect the invention resides in a method of making an assembly, the method including mounting a co-extrusion on a carrier to thereby make the assembly, wherein the co-extrusion comprises at least one clear layer and at least one coloured layer, the at least one clear layer comprising approximately 50 to 95% of the total thickness of the co-extrusion and the at least one coloured layer comprising approximately 5 to 50% of the total thickness of the co-extrusion, an outer clear layer of the at least one clear layer comprises an outer layer of the co-extrusion when mounted to the carrier, the co-extrusion has a light transmittance of between 0 and 30% and provides a look of painted glass.

In one form of the sixth aspect the light transmittance may be between 0 and 10%.

In another form of the sixth aspect the light transmittance may be between 0 and 5%.

In yet another form of the sixth aspect the at least one clear layer may comprise approximately 60 to 95% of the total thickness of the co-extrusion and the at least one coloured layer may comprise approximately 5 to 40% of the total thickness of the co-extrusion.

In still another form of the sixth aspect the co-extrusion may comprise one clear layer and one coloured layer.

In another form of the sixth aspect the co-extrusion may comprise two clear layers and one coloured layer wherein the two clear layers comprise approximately 50 to 95% of the total thickness of the co-extrusion and the one coloured layer comprises approximately 5 to 50% of the total thickness of the co-extrusion.

In still another form of the sixth aspect the co-extrusion may comprise two clear layers and two coloured layers wherein the two clear layers comprise approximately 50 to 95% of the total thickness of the co-extrusion and the two coloured layers comprise approximately 5 to 50% of the total thickness of the co-extrusion.

In yet another form of the sixth aspect the co-extrusion may comprise one clear layer and two coloured layers wherein the one clear layer comprises approximately 50 to 95% of the total thickness of the co-extrusion and the two coloured layers comprise approximately 5 to 50% of the total thickness of the co-extrusion.

In another form of the sixth aspect the co-extrusion may be a sheet.

In still another form of the sixth aspect the outer clear layer may be a critical or outer side of the co-extrusion.

In yet another form of the sixth aspect the co-extrusion may have a hard coating applied to one or both of a critical side and a non-critical side.

In another form of the sixth aspect each of the at least one clear layer and each of the at least one coloured layer may have an even or substantially even thickness.

In a seventh aspect the invention resides in a co-extruded sheet comprising at least one clear layer and at least one coloured layer wherein the at least one clear layer comprises approximately 60 to 95% of total thickness of the co-extruded sheet and the at least one coloured layer comprises approximately 5 to 40% of the total thickness of the co-extruded sheet.

In an eighth aspect the invention resides in a co-extruded sheet comprising one clear layer and one coloured layer wherein the clear layer comprises approximately 50 to 95% of total thickness of the co-extruded sheet and the coloured layer comprises approximately 5 to 50% of the total thickness of the co-extruded sheet.

In a ninth aspect the invention resides in a co-extruded sheet comprising two clear layers and one coloured layer wherein the two clear layers comprise approximately 50 to 95% of total thickness of the co-extruded sheet and the coloured layer comprises approximately 5 to 50% of the total thickness of the co-extruded sheet.

In a tenth aspect the invention resides in a co-extruded sheet comprising two clear layers and two coloured layers wherein the two clear layers comprise approximately 50 to 95% of total thickness of the co-extruded sheet and the two coloured layers comprise approximately 5 to 50% of the total thickness of the co-extruded sheet.

In an eleventh aspect the invention resides in a co-extruded sheet comprising one clear layer and two coloured layers wherein the clear layer comprises approximately 50 to 95% of total thickness of the co-extruded sheet and the two coloured layers comprise approximately 5 to 50% of the total thickness of the co-extruded sheet.

In this specification, the terms “comprises”, “comprising” or similar terms are intended to mean a non-exclusive inclusion, such that a method, system or apparatus that comprises a list of elements does not include those elements solely, but may well include other elements not listed.

Further features of the present invention will become apparent from the following detailed description.

### BRIEF DESCRIPTION OF THE DRAWINGS

In order that the present invention may be readily understood and put into practical effect, reference will now be made to the accompanying illustrations, wherein like reference numerals indicate like elements and wherein:

FIG. 1 is a diagram illustrating the manufacture of a co-extruded sheet according to the invention;

FIG. 2 is a diagram illustrating the manufacture of a co-extruded sheet according to the invention;

FIG. 3 is a diagram showing a co-extruded sheet according to a first embodiment of the invention;

FIG. 4 is a diagram showing a co-extruded sheet according to a second embodiment of the invention;

FIG. 5 is a diagram showing a co-extruded sheet according to a third embodiment of the invention;

FIG. 6 is a diagram showing a co-extruded sheet according to a fourth embodiment of the invention;

FIG. 7 is a diagram showing the co-extruded sheet of FIG. 1 with a hard-coating on one side;

FIG. 8A is a perspective diagram showing the co-extruded sheet of FIG. 1 fitted to a wall;

FIG. 8B is a section diagram showing the co-extruded sheet of FIG. 1 fitted to a wall.

### DETAILED DESCRIPTION OF THE INVENTION

The invention relates, at least in part, to a co-extrusion and a method for making a co-extrusion. The inventors have surprisingly found that a co-extrusion with a thick clear layer and a thinner coloured layer has a look similar to that of painted glass. Painted glass is painted on its back side and achieves a depth of colour, lustre and gloss that is attractive to the eye. Being able to achieve a look similar to painted glass with a co-extrusion is of significant advantage because co-extruded sheets can be cut on-site with conventional carpentry or cabinet-making tools, which removes the need for off-site glass cutting and the consequent cost and time-delays. Additionally, the co-extrusion of the invention is superior to painted plastics in which the paint may be easily scratched off during handling.

“Co-extrusion” and “co-extruded sheet” as used herein means a product that has two or more layers made by extruding two or more materials through a single die with two or more orifices arranged so that the extrudates merge and weld together into a laminar structure. The invention is directed to co-extrusions in general. Although existing technology requires co-extrusions to be made in a sheet the invention is not so limited.

As used herein, the term “co-extrusion” is also used to refer to the process of making a co-extrusion or a co-extruded sheet.

“Clear layer” as used herein means a layer that is substantially clear and in combination with a coloured layer as a co-extruded sheet preferably has a light transmittance of less than about 30%. The light transmittance may be from about 0 to about 30%. In another embodiment the light transmittance may be between 0 and 20%. Preferably the light transmittance is between about 1 and 10%. More preferably the light transmittance is between about 1 and 5%.

“Coloured layer” as used herein means a layer that has one or more additive that gives the layer a colour. The coloured layer may be of any colour, hue, shade, tint, colour lightness or colour brightness. When two or more coloured layers are used preferably they are different. The colours layers may differ by any one or combination of colour, hue, shade, tint, colour lightness and/or colour brightness.

Advantageously, the co-extrusion of the invention provides the look of painted glass. To achieve this look the light transmittance of the co-extrusion may be in the range of 0 to 30%. The light transmittance may be 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30%. In one embodiment the range is 0 to 20%. Preferably the range is 0 to 10%. More preferably the range is 0 to 5%. While not wanting to be bound by any one theory the look of painted glass achieved by the present invention may be achieved by the light transmittance of the co-extrusion.

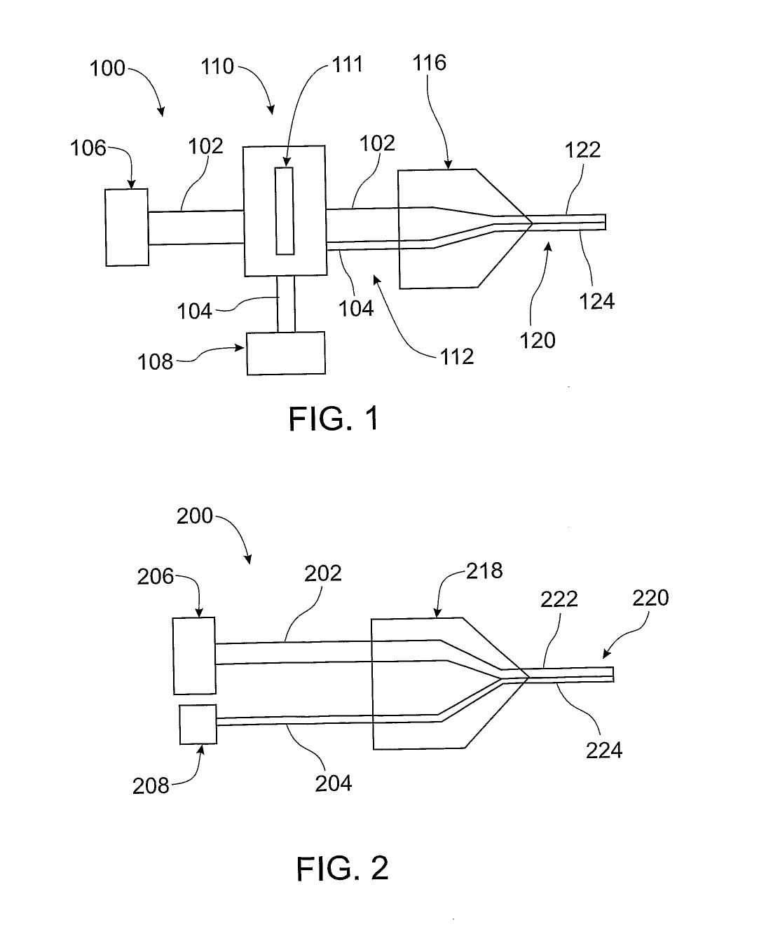

FIG. 1 illustrates feed-block co-extrusion 100, which is one suitable process for making a co-extruded sheet 120 according to the invention. As shown in FIG. 1 clear material feed 102 from main extruder 106 and coloured material feed 104 from the co-extruder 108 enter feed block 110 where they are aligned and proceed as a combined melt stream 112 to single manifold extrusion die 116 before being co-extruded as co-extruded sheet 120. In the feedblock 110 there is a plug 111 that determines how the two molten polymers 102, 104 will be layered in the co-extruded sheet 120. Hence, the clear material feed 102 and the coloured material feed 104 enter feedblock 110 separately and are selectively combined within feedblock 110. Once the clear material feed 102 and the coloured material feed 104 are selectively layered and merged in feedblock 110, the combined melt stream 112 exits feedblock 110 and enters die 116 where the combined melt stream 112 is spread to the width of die 116 and emerges as co-extruded sheet 120. The co-extruded sheet 120 may then be polished and allowed to cool.

FIG. 2 shows manifold die co-extrusion 200, which is another suitable process for making a co-extruded sheet 220 according to the invention. Clear material feed 202 from main extruder 206 and coloured material feed 204 from co-extruder 208 enter multi-manifold extrusion die 218 where they are aligned before being co-extruded as a co-extruded sheet 220.

Each of the main extruder 106, 206 and co-extruder 108, 208 converts the material fed into them into molten polymer, separately. The melt streams are then combined in either the feedblock 110 or the extrusion die 218.

A person of skill in the art is readily able to select other co-extrusion methods such as those described in “Polymer Extrusion” by Chris Rauwendaal (3^{rd} Revision, 1994, Hanser Publishers, Munich, Vienna, N.Y.), the disclosure of which is incorporated herein by reference.

The co-extruded sheets described below may be produced by method 100, method 200 or by another co-extrusion method selected by a person of skill in the art. Where the co-extruded sheet of the invention has more than two layers it is understood that an appropriate number of extra co-extruders may be used, for example, a three layered co-extruded sheet could be made using one main extruder and two co-extruders or splitting the melt from either the main or co-extruder into two or more layers.

Main extruder 106, 206 is usually the largest extruder and has the highest throughput rate compared to co-extruders 108, 208. Therefore, for example, in a two-layered sheet configuration, the clear material feed 102, which is to comprise the relatively thick layer, is fed into the main extruder 106, 206.

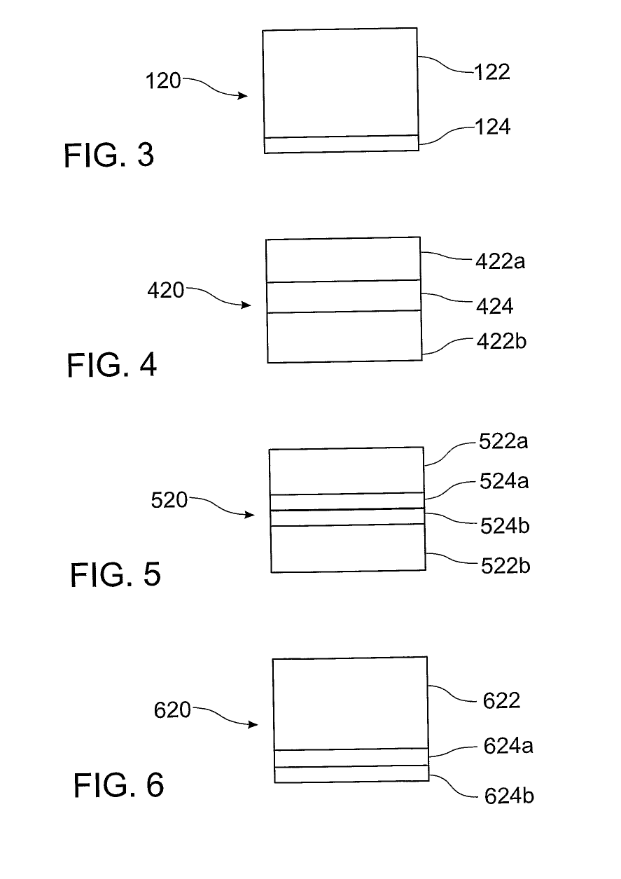

FIG. 3 shows one embodiment of a co-extruded sheet 120 according to the invention. Co-extruded sheet 120 has a clear layer 122 that has a thickness that is 90% of the total thickness of co-extruded sheet 120 and a coloured layer 124 that is 10% of the total thickness of co-extruded sheet 120.

In other embodiments the thickness of clear layer 122 is 50 to 95% of the total thickness of co-extruded sheet 120. Clear layer 122 may have a thickness of 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94 or 95% of the total thickness of co-extruded sheet 120.

In other embodiments the thickness of coloured layer 124 is 5 to 50%. Coloured layer 124 may have a thickness of 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50% of the total thickness of co-extruded sheet 120.

Referring to FIG. 1 it can be seen that the critical side of co-extruded sheet 120, i.e. the upwardly facing side of co-extruded sheet 120 as it emerges from extrusion die 116, is the clear layer 122 side of co-extruded sheet 120. Advantageously, by having clear layer 122 as the critical side the co-extruded sheet 120, when installed with the critical side on display, is able to achieve a look similar to painted glass.

The coloured layer 124 is the bottom facing side of co-extruded sheet 120 as it emerges and is the non-critical side, which is prone to defects and minor damage because it is the side that is contacted during transport of co-extruded sheet 120.

FIG. 4 shows another embodiment of a co-extruded sheet 420 according to the invention in which a coloured layer 424 is located between, or is sandwiched between, an upper clear layer 422a and a lower clear layer 422b.

Upper clear layer 422a has a thickness of 40% of the total thickness, lower clear layer 422b also has a thickness of 40% of the total thickness and the coloured layer 424 has a thickness of 20% of the total thickness of co-extruded sheet 420.

FIG. 5 shows another embodiment of a co-extruded sheet 520 according to the invention in which two coloured layers 524a, 524b are located between, or sandwiched between, an upper clear layer 522a and a lower clear layer 522b. As shown in FIG. 5 upper clear layer 522a adjoins upper coloured layer 524a, upper coloured layer 524a adjoins lower coloured layer 524b and lower coloured layer 524b adjoins lower clear layer 522b.

Upper clear layer 522a has a thickness of 40% of the total thickness, lower clear layer 522b also has a thickness of 40% of the total thickness, upper coloured layer 524a has a thickness of 10% of the total thickness and lower coloured layer 524b has a thickness of 10% of the total thickness of co-extruded sheet 520.

FIG. 6 shows yet another embodiment of a co-extruded sheet 620 according to the invention in which two coloured layers 624a, 624b are located beneath clear layer 622. As shown in FIG. 6 clear layer 622 adjoins upper coloured layer 624a, and upper coloured layer 624a adjoins lower coloured layer 624b.

Clear layer 622 has a thickness of 80% of the total thickness, upper coloured layer 624a has a thickness of 10% of the total thickness and lower coloured layer 624b has a thickness of 10% of the total thickness of co-extruded sheet 620.

The thickness of clear layer 622, the combined thickness of clear layers 422a and 422b and the combined thickness of clear layers 522a and 522b is 80% of the total. In other embodiments the thickness of clear layer 622, the combined thickness of clear layers 422a and 422b and the combined thickness of clear layers 522a and 522b is between 50 and 95% of the total thickness of the co-extruded sheet. The combined thickness may be 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94 or 95%.

The thickness of coloured layer 424, the combined thickness of coloured layers 524a and 524b and the combined thickness of coloured layers 624a and 624b is 20% of the total. In other embodiments the thickness of coloured layer 424, the combined thickness of coloured layers 524a and 524b and the combined thickness of coloured layers 624a and 624b is between 5 and 50% of the total thickness of the co-extruded sheet. The combined thickness may be 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 40, 41, 42, 43, 44, 45, 46, 47, 48, 49, or 50%.

The upper and lower layers within one co-extruded sheet need not be of equal thickness. For example upper clear layer 422a may have a thickness of 20% of the total and lower clear layer 422b may have a thickness of 60% of the total.

Co-extruded sheets 120, 220, 420, 520, 620 have a total thickness of approximately 6.0 mm. In other embodiments the total thickness of co-extruded sheet 120, 420, 520, 620 is between 1.0 mm and 20.0 mm. The total thickness may be 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, 12.0, 12.1, 12.2, 12.3, 12.4, 12.5, 12.6, 12.7, 12.8, 12.9, 13.0, 13.1, 13.2, 13.3, 13.4, 13.5, 13.6, 13.7, 13.8, 13.9, 14.0, 14.1, 14.2, 14.3, 14.4, 14.5, 14.6, 14.7, 14.8, 14.9, 15.0, 15.1, 15.2, 15.3, 15.4, 15.5, 15.6, 15.7, 15.8, 15.9, 16.0 16.1, 16.2, 16.3, 16.4, 16.5, 16.6, 16.7, 16.8, 16.9, 17.0, 17.1, 17.2, 17.3, 17.4, 17.5, 17.6, 17.7, 17.8, 17.9, 18.0, 18.1, 18.2, 18.3, 18.4, 18.5, 18.6, 18.7, 18.8, 18.9, 19.0, 19.1, 19.2, 19.3, 19.4, 19.5, 19.6, 19.7, 19.8, 19.9 or 20.0 mm.

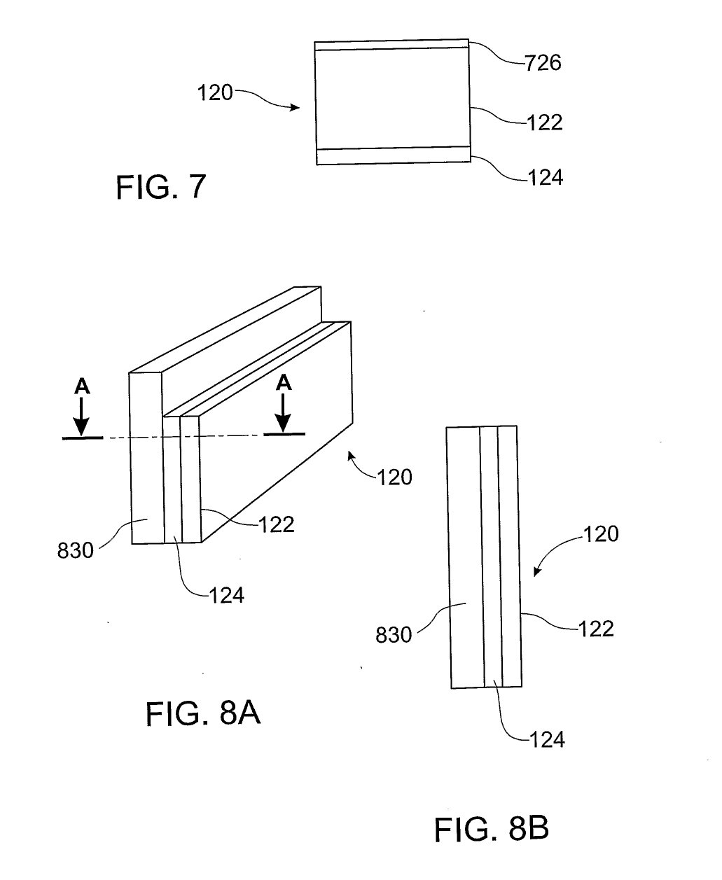

FIG. 7 shows co-extruded sheet 120 with the addition of a hard coating 726 that has been applied to clear layer 122. The hard coating 726 has been applied using solvent based hard coating with the coating being dried in a curing oven.

Hard coating 726 is polysiloxane. A person of skill in the art is readily able to select other hard coating materials.

Hard coating 726 has a thickness of 6 μm. In other embodiments the thickness of hard coating 726 is between 2 and 40 μm. The thickness of hard coating 726 may be 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40 μm.

Advantageously, because clear layer 122 is the critical layer hard coating 726 has fewer defects than it would if it were applied to the non-critical side. This has the advantage of a more attractive look.

In another embodiment hard coating 726 is cured using UV radiation.

A person of skill in the art is readily able to select other hard coating methods.

Hard coating 726 may also be applied to the non-critical side.

One use for the co-extruded sheet of the invention is to provide a surface when applied to a carrier. Examples of suitable carriers include a wall and a bench. The carrier may be any suitable material such as wood, fibreboard, medium density fibreboard, masonite and plasterboard.

When fitted to a kitchen wall the co-extruded sheet of the invention is useful as a splashback, i.e. the area behind a sink or near a liquid outlet that protects a wall from splashes.

FIG. 8A is a perspective diagram showing an example where co-extruded sheet 120 is fitted to a wall 830. As shown in FIG. 8 the clear layer 122 is the outer layer or exposed layer and is the furthest side of co-extruded sheet 120 from wall 830. FIG. 8B is a section diagram taken through line “A-A” in FIG. 8A also showing that clear layer 122 is the outer layer or exposed layer and is the furthest side of co-extruded sheet 120 from wall 830

The co-extruded sheet of the invention may be fitted to a carrier by for example, a glue, a screw, a bolt, adhesive tape or other fixative. A person of skill in the art is readily able to select an appropriate fixative.

The co-extruded sheet of the invention may also be used without a carrier and may itself form a wall or barrier, such as, when used as a wall or partition between office, or other such, cubicles.

The layers of co-extruded sheet 120, 220, 420, 520, 620 may be made from any suitable polymer, copolymer modified polymer, modified copolymer such as, for example polymethylmethacrylate (PMMA), polycarbonate (PC), poly(ethylene terephthalate) (PET), polystyrene (PS), styrene-acrylonitrile copolymer (SAN), glycol modified PET (PETG), and high impact polystyrene (HIPS). A person of skill in the art is able to select other suitable polymers.

Any suitable modifier or additive may be used with the polymer, copolymer, modified polymer or modified copolymer. Suitable modifiers and additives include flame retardants, colourants, UV absorbers and impact modifiers.

So that the invention may be readily understood and put into practical effect, the following non-limiting Examples are provided

### EXAMPLES

### Example 1

### Production of Co-Extrusions

Four (4) co-extrusions were prepared in accordance with the above. The co-extrusions all had a single clear layer and a single coloured layer. As shown in Table 1, the total thickness of all four (4) co-extrusions was six (6) mm and the thickness of the clear layer varied from one (1) mm to five (5) mm.

Coextruded sheet samples were made using a 150 mm screw diameter vented main extruder for the layers greater than 50% of total thickness and a 60 mm diameter vented coextruder for the layers smaller than 50%. Clear layer was PMMA and coloured layer PMMA plus a PMMA based masterbatch. The colour produced was white, the thickness 6 mm and the light transmittance was 0 to 5%.

The processing temperatures were kept below 250 degrees Celsius to prevent depolymerisation and achieve a high gloss finish with low defect rate. Samples were made on a PMMA coextrusion line manufactured by Breyer GmbH in Germany.

### Assessment of Co-Extrusions

There is no quantitative test that allows accurate measurement of the depth of colour and look of painted glass achieved by the present claimed invention. Accordingly, the co-extrusions of EXAMPLE 1 were assessed qualitatively by a technician skilled in the manufacture of co-extrusions. The results of the assessment are shown in Table 1 below.

TABLE 1
Qualitative assessment of co-extrusion

| Clear layer | Coloured layer | |
|---|---|---|
| thickness mm (%) | thickness (mm) | Observations |
| 1 (16.67) | 5 (83.33) | No perceived depth of |
| | | colour. |
| 2 (33.33) | 4 (66.67) | Minor depth of colour. |
| 4 (66.67) | 2 (33.33) | Good depth of colour, similar |
| | | to painted glass. |
| 5 (83.33) | 1 (16.67) | Excellent depth of colour, |
| | | very similar look to painted |
| | | glass. |

### Example 2

### Production of Co-Extrusions

Four (4) co-extrusions were prepared. The co-extrusions all had two clear outer layers and one single coloured layer sandwiched between the clear layers. As shown in Table 2, the total thickness of all four (4) co-extrusions was twelve (12) mm and the thickness of the clear layers varied from one (1) mm to five (5) mm.

Coextruded sheet samples were made using a 150 mm screw diameter, vented main extruder for the layer/layers combining to give greater than 50% of total sheet thickness and a 60 mm diameter vented coextruder for the layer/layers combining to give less than 50% of total sheet thickness. Clear layers were PMMA and the coloured layer PMMA plus a PMMA based masterbatch. The colour produced was white, achieving a light transmission of 0-5%.

The processing temperatures were kept below 250 degrees Celsius to prevent depolymerisation and achieve a high gloss finish with low defect rate. Samples were made on a PMMA coextrusion line manufactured by Breyer GmbH in Germany.

### Assessment of Co-Extrusions

Assessment was carried out as described in Example 1 and the results are shown in Table 2.

TABLE 2
Qualitative assessment of co-extrusion

| Clear layer | | Clear layer | |
|---|---|---|---|
| thickness mm | Coloured layer | thickness mm | |
| (%) | thickness (mm) | (%) | Observations |
| 1 (8.33) | 10 (83.34) | 1 (8.33) | No perceived depth of |
| | | | colour. |
| 2 (16.67) | 8 (66.67) | 2 (16.67) | Minor depth of colour. |
| 4 (33.33) | 4 (33.33) | 4 (33.33) | Good depth of colour, |
| | | | similar to painted |
| | | | glass. |
| 5 (41.67) | 2 (16.67) | 5 (41.67) | Excellent depth of |
| | | | colour, very similar |
| | | | look to painted glass. |

### Example 3

### Production of Co-Extrusions

Two (2) co-extrusions were prepared. The co-extrusions all had two clear outer layers, one white coloured layer and one black coloured layer, the coloured layers were adjacent and sandwiched between the clear layers. As shown in Table 3, the total thickness of the co-extrusions was eight (8) mm and twelve (12) mm and the thickness of the clear layers was three (3) mm to five (5) mm.

Coextruded sheet samples were made using a 150 mm screw diameter vented main extruder for the clear layers, a 60 mm diameter vented coextruder for the white coloured layer and a 45 mm diameter vented coextruder for the black layer. Clear layers were PMMA and the coloured layers PMMA plus a PMMA based masterbatch. Produced colour was white and black, achieving a light transmission of 0-1%.

The processing temperatures were kept below 250 degrees Celsius to prevent depolymerisation and achieve a high gloss finish with low defect rate. Samples were made on a PMMA coextrusion line manufactured by Breyer GmbH in Germany.

### Assessment of Co-Extrusions

Assessment was carried out as described in Example 1 and the results are shown in Table 3.

TABLE 3
Qualitative assessment of co-extrusion

| | Coloured | Coloured | | |
|---|---|---|---|---|
| Clear layer | layer | layer | Clear layer | |
| thickness | thickness | thickness | thickness | |
| mm (%) | (mm) | (mm) | mm (%) | Observations |
| 3 (37.5) | 1 (12.5) | 1 (12.5) | 3 (37.5) | Limited depth of |
| | | | | colour. |
| 5 (41.67) | 1 (8.33) | 1 (8.33) | 5 (41.67) | Excellent depth of |
| | | | | colour, very |
| | | | | similar look to |
| | | | | painted glass. |

### Example 4

### Production of Co-Extrusions

Three (3) co-extrusions were prepared in accordance with the above. The co-extrusions all had one clear outer layer, one white middle coloured layer and one black outer coloured layer. As shown in Table 4, the total thickness of all three (3) co-extrusions was between five (5) and seven (7) mm and the thickness of the clear layers varied from three (3) mm to five (5) mm.

Coextruded sheet samples were made using a 150 mm screw diameter vented main extruder for the clear layers, a 60 mm diameter vented coextruder for the white coloured layer and a 45 mm diameter vented coextruder for the black layer. Clear layers were PMMA and the coloured layers PMMA plus a PMMA based masterbatch. The colour produced was white and black, achieving a light transmission of 0-1%.

The processing temperatures were kept below 250 degrees Celsius to prevent depolymerisation and achieve a high gloss finish with low defect rate. Samples were made on a PMMA coextrusion line manufactured by Breyer GmbH in Germany.

### Assessment of Co-Extrusions

Assessment was carried out as described in Example 1 and the results are shown in Table 4.

TABLE 4
Qualitative assessment of co-extrusion

| | Coloured | Coloured | |
|---|---|---|---|
| Clear layer | layer | layer | |
| thickness | thickness | thickness | |
| mm (%) | (mm) | (mm) | Observations |
| 3 (60) | 1 (20) | 1 (20) | Improved depth of |
| | | | colour. |
| 4 (66.67) | 1 (16.67) | 1 (16.67) | Good depth of |
| | | | colour, similar to |
| | | | painted glass. |
| 5 (71.43) | 1 (14.28) | 1 (14.28) | Excellent depth of |
| | | | colour, very |
| | | | similar look to |
| | | | painted glass. |

Advantageously, the co-extruded sheet of the invention has a look similar to painted glass but does not require glass-cutting equipment to be cut to custom fit an application. For example, a co-extruded sheet according to the invention can be cut on site using conventional carpentry or cabinet-making tools. This is of considerable advantage because it allows the co-extruded sheet of the invention to be cut on-site and installed by a carpenter or cabinet-maker without having to co-ordinate with a glass-cutter. The avoidance of a glass-cutter is also more cost-effective and avoids time delays.

Additionally, the co-extruded sheet of the invention is able to achieve a look similar to painted glass at a more cost-effective price.

Further, the co-extruded sheet of the invention is superior to painted plastics, in which the paint may be scratched off during handling so that the desired look is not achieved. Yet another advantage of the invention is that the thickness of the coloured layer may be adjusted so that minor scratches that may be introduced during transport and installation do not result in a loss of the coloured look of the co-extruded sheet.

The inventors novel use of a thick clear layer and a thinner coloured layer also has cost advantages because the clear layer is typically cheaper than the coloured layer.

The invention uses co-extrusion to advantageously achieve a homogenous union of materials. Unlike other products, no adhesion promoter is required which advantageously means that there are no cavities or joints. Further, subsequent coatings such as, painting or lamination, are not required.

Throughout the specification the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

All computer programs, algorithms, patent and scientific literature referred to herein is incorporated herein by reference.

1. A co-extrusion comprising at least one clear layer and at least one coloured layer wherein the at least one clear layer comprises approximately 50 to 95% of the total thickness of the co-extrusion and the at least one coloured layer comprises approximately 5 to 50% of the total thickness of the co-extrusion, the co-extrusion having a light transmittance of between 0 and 30% and providing a look of painted glass.

2. The co-extrusion of claim 1 wherein the light transmittance is between 0 and 10%.

3. The co-extrusion of claim 1 wherein the light transmittance is between 0 and 5%.

4. The co-extrusion of claim 1 wherein the at least one clear layer comprises approximately 60 to 95% of the total thickness of the co-extrusion and the at least one coloured layer comprises approximately 5 to 40% of the total thickness of the co-extrusion.

5. The co-extrusion of claim 1 comprising one clear layer and one coloured layer.

6. The co-extrusion of claim 1 comprising two clear layers and one coloured layer wherein the two clear layers comprise approximately 50 to 95% of the total thickness of the co-extrusion and the one coloured layer comprises approximately 5 to 50% of the total thickness of the co-extrusion.

7. The co-extrusion of claim 1 comprising two clear layers and two coloured layers wherein the two clear layers comprise approximately 50 to 95% of the total thickness of the co-extrusion and the two coloured layers comprise approximately 5 to 50% of the total thickness of the co-extrusion.

8. The co-extrusion of claim 1 comprising one clear layer and two coloured layers wherein the one clear layer comprises approximately 50 to 95% of the total thickness of the co-extrusion and the two coloured layers comprise approximately 5 to 50% of the total thickness of the co-extrusion.

9. The co-extrusion of claim 1 wherein the co-extrusion comprises a sheet.

10. The co-extrusion of claim 1 wherein an outer clear layer of the at least one clear layer is on a critical side of the co-extrusion.

11. The co-extrusion of claim 1 comprising a hard coating applied to the critical side.

12. The co-extrusion of claim 1 comprising a hard coating applied to the non-critical side.

13. The co-extrusion of claim 1 comprising a hard coating applied to both the critical side and the non-critical side.

14. The co-extrusion of claim 1 wherein each of the at least one clear layer and each of the at least one coloured layer have an even thickness.

15. An article comprising the co-extrusion according to claim 1.

16. The article of claim 15 comprising a sheet suitable for mounting on a wall.

17. The article of claim 15 comprising a sheet suitable for use as a wall.

18. The article of claim 15 comprising a sheet suitable for use as a partition.

19. The article of claim 15 comprising a sheet suitable for use as a barrier.

20. An assembly comprising a co-extrusion mounted to a carrier, wherein the co-extrusion comprises at least one clear layer and at least one coloured layer, the at least one clear layer comprising approximately 50 to 95% of the total thickness of the co-extrusion and the at least one coloured layer comprising approximately 5 to 50% of the total thickness of the co-extrusion and an outer clear layer of the at least one clear layer comprises an outer layer of the co-extrusion when mounted to the carrier and the co-extrusion has a light transmittance of between 0 and 30% and provides a look of painted glass.

21. The assembly of claim 20 wherein the light transmittance is between 0 and 10%.

22. The assembly of claim 20 wherein the light transmittance is between 0 and 5%.

23. The assembly of claim 20 wherein the least one clear layer comprises approximately 60 to 95% of the total thickness of the co-extrusion and the at least one coloured layer comprises approximately 5 to 40% of the total thickness of the co-extrusion.

24. The assembly of claim 20 wherein the co-extrusion comprises one clear layer and one coloured layer.

25. The assembly of claim 20 wherein the co-extrusion comprises two clear layers and one coloured layer wherein the two clear layers comprise approximately 50 to 95% of the total thickness of the co-extrusion and the one coloured layer comprises approximately 5 to 50% of the total thickness of the co-extrusion.

26. The assembly of claim 20 wherein the co-extrusion comprises two clear layers and two coloured layers wherein the two clear layers comprise approximately 50 to 95% of the total thickness of the co-extrusion and the two coloured layers comprise approximately 5 to 50% of the total thickness of the co-extrusion.

27. The assembly of claim 20 wherein the co-extrusion comprises one clear layer and two coloured layers wherein the one clear layer comprises approximately 50 to 95% of the total thickness of the co-extrusion and the two coloured layers comprise approximately 5 to 50% of the total thickness of the co-extrusion.

28. The assembly of claim 20 wherein the co-extrusion comprises a sheet.

29. The assembly of claim 20 wherein the outer layer comprises a critical side of the co-extrusion.

30. The assembly of claim 20 wherein the co-extrusion has a hard coating applied to a critical side.

31. The assembly of claim 20 wherein the co-extrusion has a hard coating applied a non-critical side.

32. The assembly of claim 20 wherein the co-extrusion has a hard coating applied to both a critical side and a non-critical side.

33. The assembly of claim 20 wherein each of the at least one clear layer and each of the at least one coloured layer have an even thickness.

34. The assembly of claim 20 comprising a splashback.

35. A method of making a co-extrusion according to claim 1.

36. A method of making a co-extrusion including aligning at least one clear material from at least one extruder and at least one coloured material from at least one co-extruder into a combined melt stream to thereby make the co-extrusion, wherein the at least one clear material comprises approximately 50 to 95% of the total thickness of the co-extrusion and the at least one coloured material comprises approximately 5 to 50% of the total thickness of the co-extrusion, the co-extrusion having a light transmittance of between 0 and 30% and providing a look of painted glass.

37. The method of claim 36 wherein the light transmittance is between 0 and 10%.

38. The method of claim 36 wherein the light transmittance is between 0 and 5%.

39. The method of claim 36 wherein the at least one clear material comprises approximately 60 to 95% of the total thickness of the co-extrusion and the at least one coloured material comprises approximately 5 to 40% of the total thickness of the co-extrusion.

40. The method of claim 36 wherein one clear material from one extruder is aligned with one coloured material from one co-extruder.

41. The method of claim 36 wherein two clear materials from two extruders are aligned with one coloured material from one co-extruder and the clear materials comprise two clear layers comprising approximately 50 to 95% of the total thickness of the co-extrusion and the coloured material comprises one coloured layer comprising approximately 5 to 50% of the total thickness of the co-extrusion.

42. The method of claim 36 wherein two clear materials from two extruders are aligned with two coloured materials from two co-extruders and the two clear materials comprise two clear layers comprising approximately 50 to 95% of the total thickness of the co-extrusion and the two coloured materials comprise two coloured layers comprising approximately 5 to 50% of the total thickness of the co-extrusion.

43. The method of claim 36 wherein one clear material from one extruder is aligned with two coloured materials from two co-extruders and the clear material comprises approximately 50 to 95% of the total thickness of the co-extrusion and the two coloured materials comprises two layers comprising approximately 5 to 50% of the total thickness of the co-extrusion.

44. The method of claim 36 wherein the co-extrusion comprises a sheet.

45. The method of claim 36 wherein a clear layer of the at least one clear layer is on a critical side of the co-extrusion.

46. The method of claim 36 wherein the co-extrusion comprises a hard coating applied to a critical side.

47. The method of claim 36 wherein the co-extrusion comprises a hard coating applied to a non-critical side.

48. The method of claim 36 wherein the co-extrusion comprises a hard coating applied to both a critical side and a non-critical side.

49. The method of claim 36 wherein each of the at least one clear layer and each of the at least one coloured layer have an even thickness.

50. An article produced by the method of claim 36.

51. A method of making an assembly, the method including mounting a co-extrusion on a carrier to thereby make the assembly, wherein the co-extrusion comprises at least one clear layer and at least one coloured layer, the at least one clear layer comprising approximately 50 to 95% of the total thickness of the co-extrusion and the at least one coloured layer comprising approximately 5 to 50% of the total thickness of the co-extrusion and an outer clear layer of the at least one clear layer comprises an outer layer of the co-extrusion when mounted to the carrier and the co-extrusion has a light transmittance of between 0 and 10% and provides a look of painted glass.

52. The method of claim 51 wherein the light transmittance is between 0 and 10%.

53. The method of claim 51 wherein the light transmittance is between 0 and 5%.

54. The method of claim 51 wherein the at least one clear layer comprises approximately 60 to 95% of the total thickness of the co-extrusion and the at least one coloured layer comprises approximately 5 to 40% of the total thickness of the co-extrusion.

55. The method of claim 51 wherein the co-extrusion comprises one clear layer and one coloured layer.

56. The method of claim 51 wherein the co-extrusion comprises two clear layers and one coloured layer wherein the two clear layers comprise approximately 50 to 95% of the total thickness of the co-extrusion and the coloured layer comprises approximately 5 to 50% of the total thickness of the co-extrusion.

57. The method of claim 51 wherein the co-extrusion comprises two clear layers and two coloured layers wherein the two clear layers comprise approximately 50 to 95% of the total thickness of the co-extrusion and the two coloured layers comprise approximately 5 to 50% of the total thickness of the co-extrusion.

58. The method of claim 51 wherein the co-extrusion comprises one clear layer and two coloured layers wherein the one clear layer comprises approximately 50 to 95% of the total thickness of the co-extrusion and the two coloured layers comprise approximately 5 to 50% of the total thickness of the co-extrusion.

59. The method of claim 51 wherein the co-extrusion comprises a sheet.

60. The method of claim 51 wherein the exposed face is be a critical side of the co-extrusion.

61. The method of claim 51 wherein the co-extrusion has a hard coating applied to a critical side.

62. The method of claim 51 wherein the co-extrusion has a hard coating applied to a non-critical side.

63. The method of claim 51 wherein the co-extrusion has a hard coating applied to both a critical side and a non-critical side.

64. The method of claim 51 wherein each of the at least one clear layer and each of the at least one coloured layer have an even thickness.
